(19) United States
(12) Patent Application Publication
(10) Pub. No.: US 2023/0186573 A1
(43) Pub. Date: Jun. 15, 2023

(54) COMPUTER ENHANCED MAINTENANCE SYSTEM

(71) Applicant: SANDVIK LTD, Dungannon (GB)

(72) Inventors: Stuart GRAYDON, Tyrone (GB); Patrick FORREST, Tyrone (GB)

(21) Appl. No.: 17/908,949

(22) PCT Filed: Mar. 6, 2020
(86) PCT No.: PCT/EP2020/056034

§ 371 Date: Sep. 2, 2022

(51) Int. Cl. G06T 19/00; G06T 19/20; G06T 5/50; G06V 10/25; G06F 3/01; G06F 3/16; G02B 27/01; G06Q 30/0601

(52) U.S. Cl. CPC G06T 19/006; G02B 27/0172; G06F 3/16; G06F 3/017; G06Q 30/0601; G06T 5/50; G06T 19/20; G06V 10/25; G06T 2207/20221; G06T 2219/2012

(57) ABSTRACT

A device for assisting with the maintenance of a machine. The device has a user interface for displaying an augmented reality scene, a camera for capturing in real time video of an area of interest for inclusion in the augmented reality scene, a positioning module for determining the position of the device relative to the machine, a shape recognition module for recognizing the actual component of the machine in the video, a database of virtual components and associated maintenance, assembly and/or disassembly instructions, which are displayable in the augmented reality scene and a matching module for matching the virtual component to the corresponding actual component to show a user where maintenance is required and which links to the database to provide maintenance instructions.

### FIELD OF THE INVENTION

The invention relates to a device and method for assisting with the maintenance of work machines such as mobile stone crushers and screeners and in particular to the identification of faults and replacement of components in machinery.

### BACKGROUND TO THE INVENTION

A crusher is a machine designed to reduce large rocks into smaller rocks, gravel, or rock dust. Crushers may be used to reduce the size, or change the form, of waste materials so they can be more easily disposed of or recycled, or to reduce the size of a solid mix of raw materials (as in rock ore), so that pieces of different composition can be differentiated.

Mining, quarrying demolition and recycling operations use crushers, commonly classified by the degree to which they fragment the starting material, with primary and secondary crushers handling coarse materials, and tertiary and quaternary crushers reducing ore particles to finer gradations. Each crusher is designed to work with a certain maximum size of raw material, and often delivers its output to a screening machine which sorts and directs the product for further processing.

FIG. 1a is a first side view of a crusher, FIG. 1b is a second side view of the crusher and FIG. 1c is a plan view of the crusher. In these figures, the crusher 1 is shown to comprise a hopper 3 for receiving unprocessed rocks , a crusher box 5 where the rocks are crushed, a side conveyor 7 a hydraulic control box 9, a main conveyor 11, a power pack 13, an electrical control box 15, hopper doors 17 and tracks 19. The non-drive side 21 and drive side 23 are shown in FIG. 1c. A variant can include a screen in between the feed conveyor and the crusher. In addition, the machines may be powered using diesel/hydraulic systems or diesel/electric systems.

FIG. 2 is a perspective view of a similar crusher in which the following features are shown. A chassis with tracks, hydraulic tank, feeder conveyor, legs, control cabinets, main output conveyor, drive guard and belt tensioning system, cone crusher and feed box, maintenance walkway, cone lubrication tank, power pack and hopper.

Machines such as the crushers illustrated in FIGS. 1a-c and 2, are complex, expensive and are built with high quality components made from high specification materials to allow the components to withstand harsh environments at extreme temperatures and weather conditions and where a significant amount of dust and rock particulates are in the local environment.

The machines contain a wide range of sensors which measure the performance of the machine in a number of different ways for example, the fuel efficiency, use of consumable components and the like. The sensors also provide fault finding information and, in some cases, may communicate service and fault information to the manufacturer via computing means integrated into the machine.

Accordingly, regular maintenance of these machines and replacement of failed or worn components is essential. Given their high cost and the substantial investment that is required to purchase a crusher, mechanical failure and time off-line is highly undesirable.

Typically, machine servicing is conducted by the manufacturer’s distributor. In general, there are a variety of levels of expertise and levels to which distributors of different types are authorised to carry out maintenance. Main distributors have a greater level of expertise by virtue of them having more work, more employees and therefore do more and different types of services. In addition, a manufacturer may control access to information required to conduct certain types of servicing and repair with access granted depending upon the importance and seniority of the distributor. Machine operators and owners may also have permission to carry out certain types of repair and maintenance.

One problem associated with operation and maintenance of these machines is that they are often used in very remote locations for open cast mining and the like. Therefore, if they require maintenance, the cost and time required increase significantly, especially for machines which are not networked or which are in a location where connectivity is poor. Some associated issues are as follows.

1. It is impractical and very expensive to shut down the machine and transport it to a main distributor for routine maintenance.

2. Cost of engineer to travel to machine to assess maintenance issues.

3. Possible separate cost of engineer to travel to machine to repair machine, replace parts or provide routine maintenance.

### SUMMARY OF THE INVENTION

In accordance with a first aspect of the invention there is provided a device for assisting with the maintenance of a machine, the device comprising:
a user interface for displaying an augmented reality scene;
a camera for capturing in real time video of an area of interest for inclusion in the augmented reality scene;
a positioning module for determining the position of the device relative to the machine;
a shape recognition module for recognising the actual component of the machine in the video;
a database of virtual components and associated maintenance instructions which are displayable in the augmented reality scene;
a matching module for matching the virtual component to the corresponding actual component to show a user where maintenance is required and which links to the database to provide maintenance instructions.

It will be appreciated that the term Augmented Reality (AR) may be substituted with the term Mixed Reality (MR). Both terms convey the use of technology to provide a user interface that merges real and virtual worlds.

In addition, the term maintenance includes tasks such as the assembly and disassembly of components.

In at least one embodiment, the device is a handheld device.

In at least one embodiment, the handheld device is a tablet computer or smartphone.

In at least one embodiment, the device is an augmented reality headset.

The term headset includes but is not limited to, headwear, eyewear and other similar wearable technology.

In at least one embodiment, the user interface is a graphical user interface.

In at least one embodiment, the user interface is an audio output.

In at least one embodiment, the user interface combines a graphical user interface and an audio output.

In at least one embodiment, the graphical user interface is controlled by physical interaction with the handheld device.

In at least one embodiment, the graphical user interface is controlled by gestures which interact with objects in the augmented reality environment.

In at least one embodiment, the graphical user interface comprises augmented reality experience or gaming object and animation combined with instruction windows.

In at least one embodiment, the instructions comprise fault finding instructions.

In at least one embodiment, instructions comprise component replacement or assembly or disassembly instructions.

In at least one embodiment, the positioning module comprises a GPS location device.

In at least one embodiment, the positioning module comprises a local network device which determines the position of the device with respect to nodes in a local network.

In at least one embodiment, the positioning module comprises a combination of GPS and local network.

The local network may comprise (Wi-Fi™, Bluetooth™, mesh network etc) or alternatively connected to the machines telematics API through an internet connection (GSM, 3G, 4G, 5G).

In at least one embodiment, the positioning module detects and plots the position of the device with respect to the machine.

In at least one embodiment, the positioning module provides updated device position information to allow the augmented reality scene to reflect a change of location of the device with respect to the machine.

In at least one embodiment, the positioning module provides updated device position information to allow a change in the position of the virtual component with respect to the machine as shown by the augmented reality experience or gaming object of the area of interest.

In at least one embodiment, the matching module overlays the actual component with a virtual gaming object.

In at least one embodiment, matching as indicated by an alert on the user interface.

In at least one embodiment the alert is a flashing virtual component.

In at least one embodiment, the alert is a change in colour of the virtual component. In one in body meant the alert is a sound.

In at least one embodiment, the machine is a stone crusher.

In at least one embodiment the machine is a screener.

In at least one embodiment, a reference marker is provided at a predetermined location on the machine to position the device with respect to the machine.

In at least one embodiment, the reference marker is a barcode.

In at least one embodiment, the reference marker is a QR code

In at least one embodiment, the reference marker is scanned and the augmented reality scene is mapped out on the user interface with respect to that reference point.

In at least one embodiment, a reference marker is provided at a predetermined location on the machine to orient the AR experience with respect to the machine.

In at least one embodiment, the reference marker is a barcode.

In at least one embodiment, the reference marker is a QR code

In at least one embodiment, the reference marker is scanned and the augmented reality scene is mapped out in the device with respect to that reference point.

In at least one embodiment GPS detects and maps into the AR scene, changes in the position of the headset with respect to the machine.

In accordance with a second aspect of the invention there is provided a computer implemented method for assisting with the maintenance of machinery, the method comprising the steps of:
using a device to capture, in real time, a video of an area of interest for inclusion in an augmented reality scene on a user interface of the device;
determining the position of the device relative to a machine requiring maintenance;
recognising an actual component of the machine in the video;
accessing a database of virtual components and associated maintenance instructions which are displayable in the augmented reality scene;
matching the virtual component to the corresponding actual component to show a user where maintenance is required and which links to the database to provide maintenance instructions.

In at least one embodiment, the device is a handheld device.

In at least one embodiment, the handheld device is a tablet computer or smartphone.

In at least one embodiment, the device is an augmented reality headset.

In at least one embodiment, the user interface is a graphical user interface.

In at least one embodiment, the user interface is an audio output.

In at least one embodiment, the user interface combines a graphical user interface and an audio output.

In at least one embodiment, the graphical user interface is controlled by physical interaction with the handheld device.

In at least one embodiment, the graphical user interface is controlled by gestures which interact with objects in the augmented reality environment.

In at least one embodiment, the graphical user interface comprises augmented reality experience or gaming object and animation combined with instruction windows.

In at least one embodiment, the instructions comprise fault finding instructions. Anyone in body meant instructions comprise component replacement or assembly or disassembly instructions.

In at least one embodiment, GPS is used to determining the position of the device relative to the machine.

In at least one embodiment, the positioning module comprises a local network device which determines the position of the device with respect to nodes in a local network.

In at least one embodiment, the positioning module comprises a combination of GPS and local network.

The local network may comprise (wifi, bluetooth, mesh network etc) or alternatively connected to the machines telematics API through an internet connection (GSM, 3G, 4G and 5G).

In at least one embodiment, the positioning module detects and plots the position of the device with respect to the machine.

In at least one embodiment, the device position information is updated to allow the augmented reality scene to reflect a change of location of the device with respect to the machine.

In at least one embodiment, the device position information is updated to allow a change in the position of the virtual component with respect to the machine as shown by the video image of the area of interest.

In at least one embodiment, the matching module overlays the actual component with a virtual gaming object.

In at least one embodiment, matching is indicated by an alert on the user interface.

In at least one embodiment the alert is a flashing virtual component.

In at least one embodiment, the alert is a change in colour of the virtual component.

In at least one embodiment, the alert is a sound.

In at least one embodiment, a reference marker is provided at a predetermined location on the machine to orient the AR experience with respect to the machine.

In at least one embodiment, the reference marker is a barcode.

In at least one embodiment, the reference marker is a QR code.

In at least one embodiment, the reference marker is scanned and the augmented reality scene is mapped out in the device with respect to that reference point.

In at least one embodiment GPS detects and maps into the AR scene, changes in the position of the headset with respect to the machine.

### BRIEF DESCRIPTION OF THE DRAWINGS

The invention will be more clearly understood from the following description of an embodiment thereof, given by way of example only, with reference to the accompanying drawings, in which:

FIG. 1a is a first side view of a crusher, FIG. 1b is a second side view of the crusher and FIG. 1c is a plan view of the crusher;

FIG. 2 is a perspective view of another crusher;

FIG. 3 is a schematic diagram of an embodiment of a device in accordance with the present invention;

FIG. 4 is a schematic diagram which shows an example of the present invention connected to a machine;

FIG. 5 is a flow diagram which shows a first example of a computer implemented method in accordance with the present invention; and

FIGS. 6a to 6g is a series of screen shots from the AR interface which shows an example of the use of a device in accordance with the present invention.

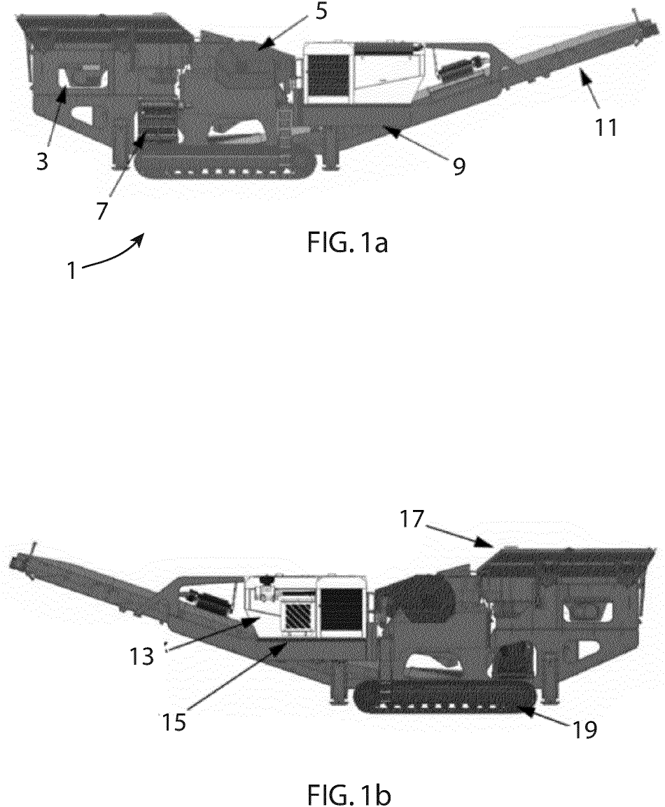

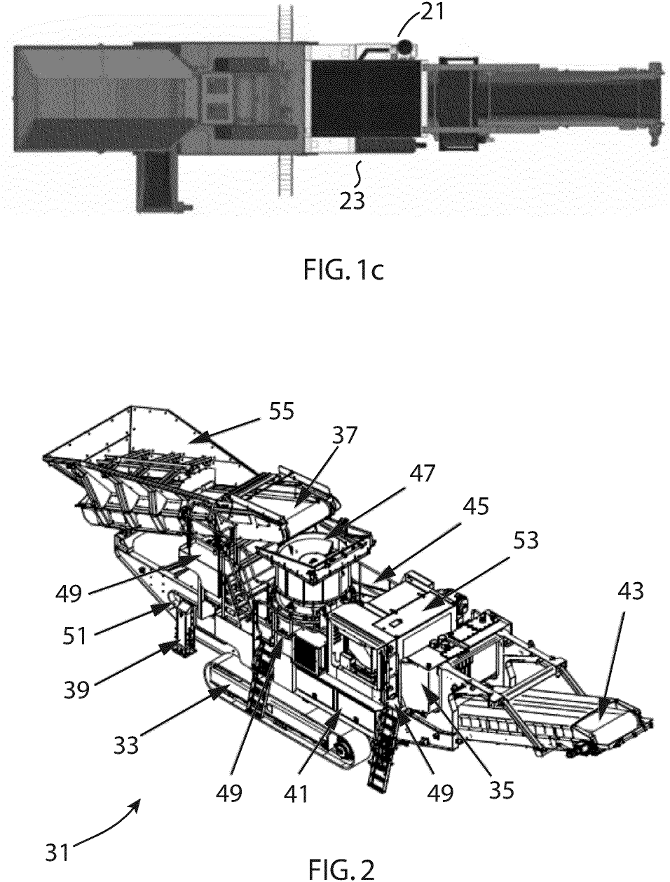

### DETAILED DESCRIPTION OF THE DRAWINGS

The device of the present invention provides a device with an augmented reality interface which assists a user in undertaking tasks such as minor repairs and component replacement without the need for this work to be done by a highly skilled engineer. In the case of work machines in remote locations where access for engineers may be difficult and where communication of data to and from the machine may be intermittent, the ability to upload and store augmented reality experiences on the machine for use as a tool for maintenance in response to physical changes on the machine is extremely useful.

The device of the present invention may be implemented as an AR headset, or as a handheld device such as a rugged tablet computer.

The machine or remote service tablet acts as its own independent server to store the augmented reality content required to be displayed on the headwear. This independent server removes the need for an internet connection so the user can avail of the experiences in an offline, remote geographic locations. Based on whether the machine is running or not, digital content is displayed on or around the machine to notify the user of “unseen” dangers. These notifications can be tailored to the location of the user relative to the machine.

In addition, a tablet computer may be used in conjunction with the AR headset by connecting the tablet to the AR headset and the work machine where the tablet has additional functionality which could be used for example for the ordering of spare parts for the creation of an order for approval which may be sent to the distributor or manufacturer. In at least one embodiment of the present invention there is an option to send a request or order straight from headwear.

In one or more embodiment of the present invention, GPS is used to allow changes in the position of the headset to be calculated and for the initial position of the headset with respect to certain parts of the machine to be mapped as exemplified below.

1. the machine, which has a wide variety of sensors detects a fault with a component of the machine using the sensors.

2. The fault is displayed on the screen in the cab of the machine along with a QR code.

3. The user scans the QR code with either an augmented reality headset or other device such as a phone or tablet.

4. Technical support which is embedded in the machines computer then takes the user through a set of step-by-step procedures for either fixing or investigating the fault to their level of authorisation and or competence.

In some cases, GPS may be replaced or augmented by a local network, for example using Wi-Fi.

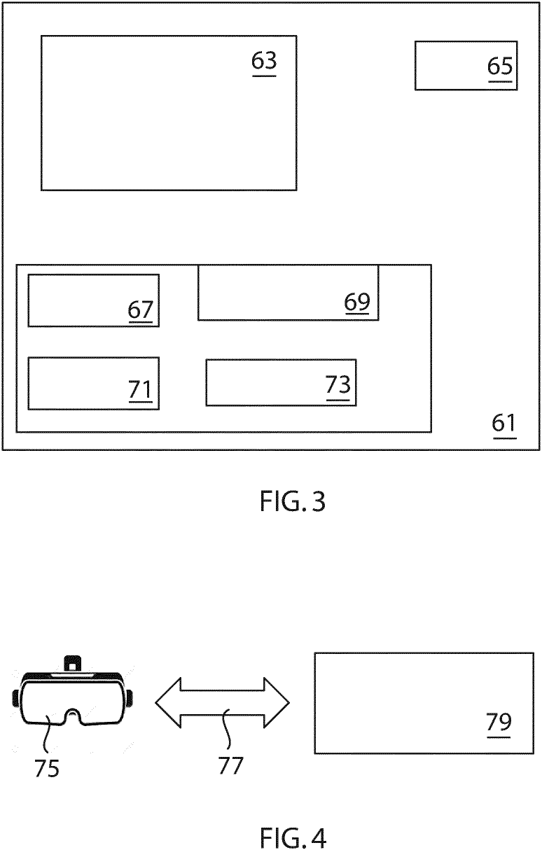

FIG. 3 is a schematic diagram which shows an example of a device in accordance with the present invention. The device 61 comprises a user interface 63, which may be a graphical user interface and an audio output on a tablet computer or may be an augmented reality environment, for example as may be provided using Microsoft HoloLens™.or similar device. The device also has a camera 65 which is used to capture as video, the surroundings of the device and in particular, the machine which requires maintenance. In at least one embodiment of the present invention, where bandwidth and location allows, video may be streamed and real time remote support provided.

The device uses positioning module 67 which determines the position of the device relative to the machine and which may use a reference marker such as a QR code as a reference marker to orient the device relative to the machine. Shape recognition module 69 is used to recognise the actual component of the machine in the video. The database of virtual components and associated maintenance instructions 73 are displayable in the augmented reality scene. Matching module 71 matches the virtual component to the corresponding actual component to show a user where maintenance is required and which links to the database to provide maintenance instructions. FIG. 4 shows the device embodied as a AR headset 75 which is connectable 77 to the machine 79, via a Wi-Fi link.

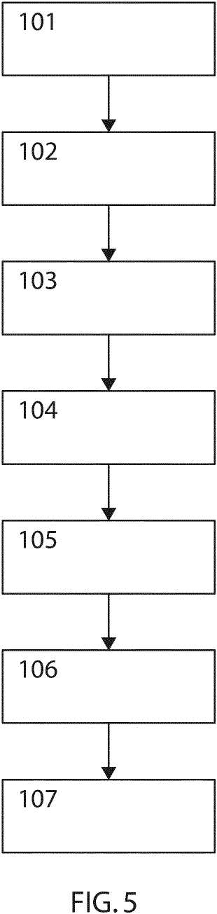

In one example of the method of the present invention as shown in FIG. 5

101. An AR device captures, in real time, a video of an area of interest.

102. The video is incorporated into an augmented reality scene which is displayed on the device user interface.

103. The position of the device relative to a work machine is determined.

104. The position of an actual component of the machine in the video is determined.

105. A database of virtual components and associated maintenance instructions which are displayable in the augmented reality scene is accessed;

106. The virtual component is matched to the corresponding actual component to show a user where maintenance is required.

107. links to the database to provide maintenance instructions. This experience can also be downloaded onto / installed onto the device for offline use

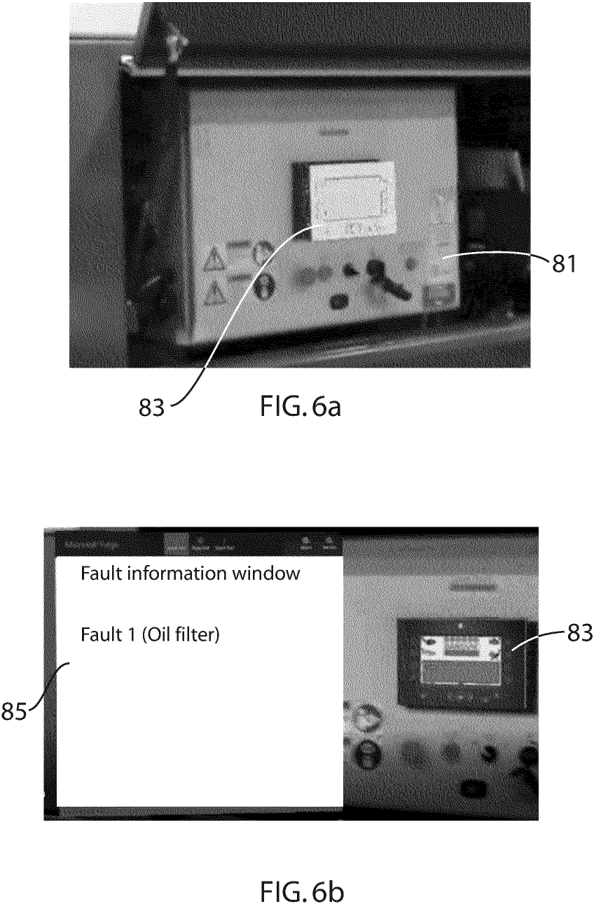

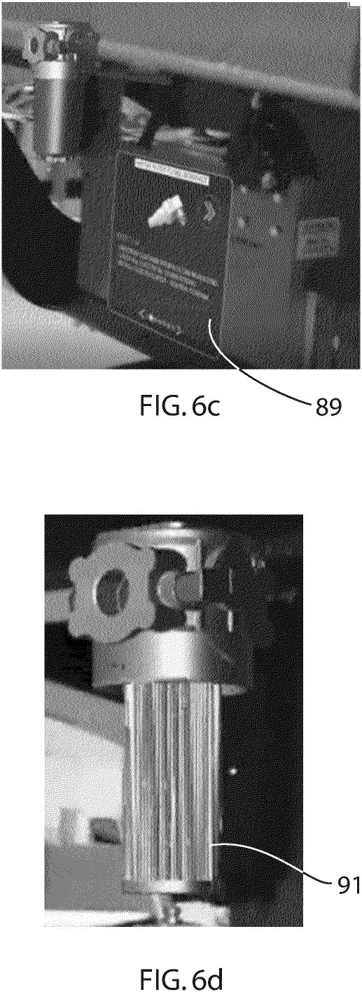

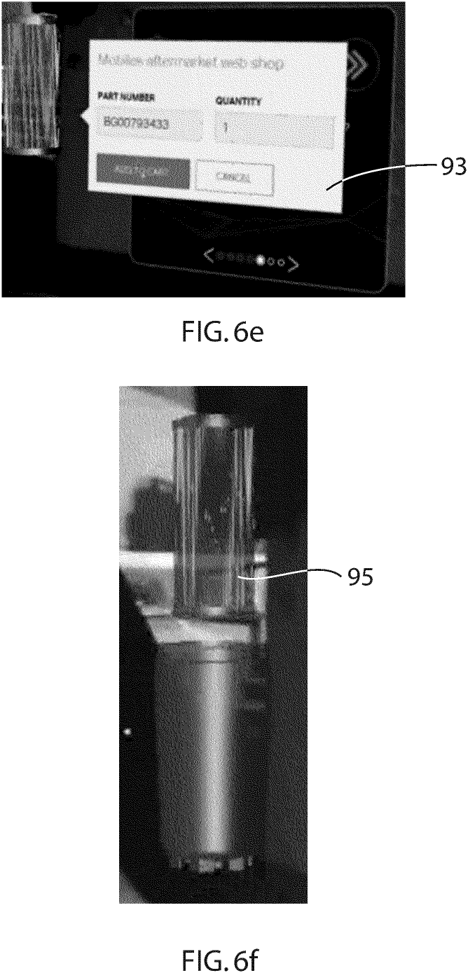

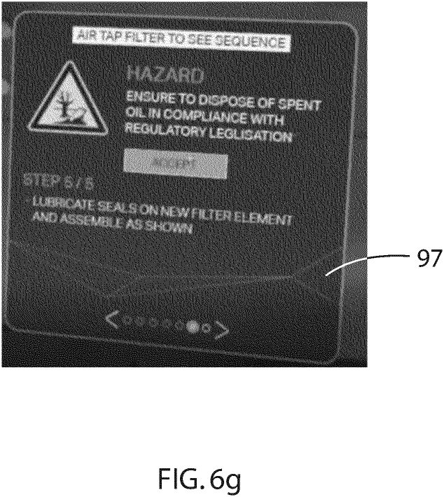

In another example of the present invention, a user is taken through an AR experience of using interactive work instructions as shown with reference to FIGS. 6a to 6g which are screen shots from an AR GUI of an example of a device in accordance with the present invention.

201. The user puts on the AR headset and looks towards the machine control panel 81, as shown in FIG. 6a. The control panel 81 has virtual component (VC) control panel 83 overlaid on actual component (AC) control panel 81.

202. A VC control panel 83 is highlighted and an audio prompt is given to the user to start the machine ignition on AC control panel 81.

203. The user selects VC control panel 83 using a gesture in the AR environment. A fault window 85 opens.

204. The user gestures to select “fault 1” which relates to the replacement of an oil filter.

205. The user can select to resolve the issue to get full diagnostic instructions 89.

206. A VC oil filter appears in the user’s field of view and the AR headset guides the user to the fault site, which is a filter assembly at the rear of the machine. The user moves the AR device to rear of machine, pointing the camera at the machine to allow overlay of the VC oil filter to be positioned to match the position of the real oil filter.

207. When the user arrives at the filter assembly an instruction window appears on the GUI,

208. The user gestures to confirm they are ready to proceed.

209. The user interface informs the user that the first step in the repair is to check and clean pressure switch, this step is shown on the VC pressure switch 89 FIG. 6c.

210. The user gestures to confirm step is complete.

211. The filter to be replaced is highlighted and an audio explanation provided.

212. The user gestures to confirm step is complete.

213. The user is instructed to place a container under the filter to collect spent oil. VCs are shown in an animation with oil falling into the container and the filter being put into the container 97, FIG. 6g.

214. The VC filter is selected and this action adds it to a cart 93 on an online portal FIG. 6e to allow a replacement to be ordered.

215. The AC filter is removed

216. Click to move to next step.

217. VC new filter shown 95 (FIG. 6f) with audio instructions to lubricate and visual assembly instructions provided on the GUI.

218. Assemble and fill new filter

219. Once done, confirm job is complete

220. Instruction to start machine and confirm fault is cleared on main control pane (FIG. 6g).

In another embodiment of the present invention, the user follows a basic step by step experience to understand work involved, but then sends a request for a competent service technician to come out and carry out activity on their behalf.

Another example of the present invention is described below as a series of process steps.

301. Switch on AR headset or handheld device to show the device graphical user interface (GUI).

302. Check safety and preparedness “take 5” notice.

303. Load work instructions.

304. Instructions relate to idler pulley replacement.

305. Written instructions appear on GUI.

306. Graphical object appears on GUI which shows a virtual component (VC) which corresponds to the actual component of the machine, in this case, the enclosure door.

307. Device pointed to the machine (headset or mobile).

308. When device camera locates the actual component (AC) door as displayed on the GUI and the position of the VC door and the AC door match or overlap to a predetermined extent, the component is highlighted on device screen.

309. The user confirms that it is the correct component by clicking or other gesture on device GUI.

310. The GUI displays a VC tool (wrench) for loosening a VC bolt to illustrate the opening of the enclosure door on the GUI. The GUI shows the location where the VC wrench should be used and the direction in which it should be turned to open the enclosure. Audio is played to reinforce and supplement the information on the GUI which informs the user how to open the enclosure door using the wrench.

311. The GUI then shows the VC enclosure door flashing green then being opened and another VC component situated behind the enclosure door is shown. This invites the user to physically open the actual enclosure door.

312. The user physically unscrews the bolt and opens the enclosure door.

313. The GUI then shows a VC securing bar which resembles the AC securing bar stowed inside the door.

314. The GUI then shows the position that the VC securing bar being moved to a securing position fixed between the door and the compartment so as to hold the enclosure open.

315. The user completes this task.

316. The user returns to the work instruction and selects the next step which is a step for unscrewing a locking nut on a turn buckle inside the enclosure.

317. The device GUI is pointed towards the AC and shows a VC enclosure and turn buckle.

318. The device GUI then shows a VC wrench moving moved towards the location of the VC turnbuckle. The animation is accompanied by audio which reinforces the instruction.

319. As before, the GUI combines graphical objects which illustrate the components and real time camera images, to create an Augmented Reality scene on the GUI. The position of the AR component and the VR components on the screen are compared and their relative location is used to assist with the maintenance task which is required.

320. The user then uses a wrench to loosen the lock nut on the turn buckle as directed.

321. The user returns to the work instruction and selects the next step which in which:
i. Uses an adjustment bar to raise idler assembly;
ii. Uses an adjustment bar to turn the top link body to extend pivot arms; and
iii. Repeat to ensure pivot arm is clear of drive belts.

322. The user returns to the work instruction and selects the next step which is a step for connecting an extendable support link.

323. The device is pointed towards the AC and shows a VC enclosure as an AR image on the GUI and the device illustrates step 322 for the user which the user completes.

324. The user returns to the work instruction and selects the next step which is measuring and recording the position of the taper lock relative to the shaft.

325. The device is pointed towards the AC and shows a VC enclosure as an AR image on the GUI and the device illustrates step 324 for the user, which the user completes.

326. The user returns to the work instruction and selects the next step which is removal of the taper lock screws and loosening the taper lock in the pulley hub.

327. The device is pointed towards the AC and shows a VC enclosure as an AR image on the GUI and the device illustrates step 326 for the user which the user completes.

328. The user returns to the work instruction and selects the next step which is removal of the taper lock hub from the shaft.

329. The device is pointed towards the AC and shows a VC enclosure as an AR image on the GUI and the device illustrates step 328 for the user which the user completes.

330. The user returns to the work instruction and selects the next step which is mounting of pre- assembled taper lock and pulley.

331. The device is pointed towards the AC and shows a VC enclosure as an AR image on the GUI and the device illustrates step 330 for the user which the user completes.

332. Subsequent steps relate to the reassembly of the component.

The description of the invention including that which describes examples of the invention with reference to the drawings may comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a memory stick or hard disk. The carrier may be an electrical or optical signal which may be transmitted via an electrical or an optical cable or by radio or other means.

The description of the invention including that which describes examples of the invention describes the use of an augmented reality (AR) systems and apparatus.

AR overlays virtual objects onto the real-world environment. AR devices like the Microsoft HoloLens and various enterprise-level “smart glasses” are transparent, letting you see everything in front of you as if you are wearing a weak pair of sunglasses. The technology is designed for completely free movement while projecting images over whatever you look at. The term mixed reality overlays and anchors virtual objects to the real world.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described but may be varied in both construction and detail.

1. A device for assisting with the maintenance of a machine, the device comprising:
a user interface for displaying an augmented reality scene;
a camera for capturing in real time video of an area of interest for inclusion in the augmented reality scene;
a positioning module for determining the position of the device relative to the machine;
a shape recognition module for recognizing an actual component of the machine in the video;
a database of virtual components and associated maintenance instructions which are displayable in the augmented reality scene; and
a matching module for matching a virtual component of the database of virtual components to a corresponding actual component to show a user where maintenance is required and which links to the database to provide maintenance instructions.

2. The device of as claimed in claim 1, whereinthe device is a handheld device.

3. The device as claimed in claim 2, wherein the handheld device is a tablet computer or smartphone.

4. The device as claimed in claim 1, wherein the device is an augmented reality headset.

5. The device as claimed in claim 1, wherein the user interface is a graphical user interface.

6. The device as claimed in claim 1, wherein the user interface is an audio output.

7. The device as claimed in claim 1, wherein the user interface combines a graphical user interface and an audio output.

8. The device as claimed in claim 5, wherein the device is a handheld device, and wherein the graphical user interface is controlled by physical interaction with the handheld device.

9. The device as claimed in claim 8, wherein the physical interaction includes gestures and or voice and/or a keyboard and/or mouse, which interact with objects in the augmented reality scene.

10. The device as claimed in claim 5, wherein the graphical user interface comprises an augmented reality experience or gaming object and animation combined with instruction windows.

11. The device as claimed in claim 1, wherein the instructions include fault finding instructions.

12. The device as claimed in claim 1, wherein the instructions include component replacement or assembly or disassembly instructions.

13. The device as claimed in claim 1, wherein the positioning module includes a GPS location device.

14. The device as claimed in claim 1, wherein the positioning module includes a Wi-Fi device, which determines a position of the device with respect to nodes in a local Wi-Fi network.

15. The device as claimed in claim 1, whereinthe positioning module detects and plots the position of the device with respect to the machine.

16. The device as claimed in claim 1, wherein the positioning module detects and plots the position of the device using a grid/mesh network of gaming objects positioned a set distance away from the machine.

17. The device as claimed in claim 1, wherein the positioning module provides updated device position information to allow the augmented reality scene to reflect a change of location of the device with respect to the machine.

18. The device as claimed in claim 1, wherein the positioning module provides updated device position information to allow a change in the position of the virtual component with respect to the machine as shown by the video image of the area of interest.

19. The device as claimed in claim 1, wherein the matching module overlays the virtual component with an actual component image received from the camera.

20. The device as claimed in claim 1, wherein matching is indicated by an alert on the user interface.

21. The device as claimed in claim 20, wherein the alert is a flashing virtual component.

22. The device as claimed in claim 20, whereinthe alert is a change in colour of the virtual component. or a sound.

23. The device as claimed in claim 1, wherein the machine is a stone crusher.

24. The device as claimed in claim 1, wherein the machine is a screener.

25. The device as claimed in claim 1, wherein a reference marker is provided at a predetermined location on the machine to orient the device with respect to the machine.

26. The device as claimed in claim 25, wherein the reference marker is a barcode.

27. The device as claimed in claim 25, wherein the reference marker is a QR code.

28. The device as claimed in claim 25, wherein the reference marker is scanned and the augmented reality scene is mapped out on the user interface with respect to that reference point.

29. The device as claimed in claim 25, wherein the device is an augmented reality headset, and wherein the reference marker is a GPS and detects and maps into the augmented reality scene, changes in a position of the headset with respect to the machine.

30. The device as claimed in claim 10,wherein a link is provided to an online e-commerce platform for the ordering of parts and/or services from within the augmented reality experience.

31. A computer implemented method for assisting with the maintenance of machinery, the method comprising the steps of:
using a device to capture, in real time, a video of an area of interest for inclusion in an augmented reality scene on a user interface of the device;
determining a position of the device relative to a machine requiring maintenance;
recognizing an actual component of the machine in the video;
accessing a database of virtual components and associated maintenance instructions, which are displayable in the augmented reality scene; and
matching a virtual component of the database of virtual components to a corresponding actual component to show a user where maintenance is required and which links to the database to provide maintenance instructions.

32. The method as claimed in claim 31, wherein the device is a handheld device, and wherein the graphical user interface is controlled by physical interaction with the handheld device.

33. The method as claimed in claim 32, wherein the graphical user interface is controlled by gestures, which interact with objects in the augmented reality scene.

34. The method as claimed in claim 1, wherein the instructions comprise fault finding instructions.

35. The method as claimed inclaim 31, wherein the instructions comprise component replacement or assembly or disassembly instructions.

36. The method of claim 31, wherein the position of the device relative to the machine is determined using GPS.

37. The method of claim 31, wherein the position of the device relative to the machine is determined using Wi-Fi.

38. The method as claimed in claim 31., wherein a positioning module detects and plots the position of the device with respect to the machine.

39. The method as claimed in claim 38, wherein device position information is updated to allow the augmented reality scene to reflect a change of location of the device with respect to the machine.

40. The method as claimed in claim 38, wherein the device position information is updated to allow a change in the position of the virtual component with respect to the machine as shown by the video image of the area of interest.

41. The method as claimed in claim 31, wherein the device includes a camera, and wherein the virtual component is overlaid with an actual component image received from the camera.

42. The method as claimed in claim 31, wherein matching is indicated by an alert on the user interface.

43. The method as claimed in claim 31, wherein the user interface comprises an augmented reality experience and a reference marker is provided at a predetermined location on the machine to orient the augmented reality experience with respect to the machine.

44. The method as claimed in claim 43, wherein the reference marker is scanned and the augmented reality scene is mapped out in the device with respect to the reference point.

45. The method as claimed in claim 31, wherein the device is an augmented reality headset, and wherein GPS detects and maps into the augmented reality scene and changes a position of the headset with respect to the machine.

46. The method as claimed in claim 31, wherein the user interface comprises an augmented reality experience, and wherein the device is linked to an online e-commerce platform for the ordering of parts and/or services from within the augmented reality experience.
